(19) United States
(12) Patent Application Publication
(10) Pub. No.: US 2023/0028021 A1
(43) Pub. Date: Jan. 26, 2023

(54) A BRAKING SYSTEM AND A BRAKE ACTIVATION UNIT

(71) Applicant: FORTESCUE METALS GROUP LTD, East Perth, Western Australia (AU)

(72) Inventors: Tim ROCHE, East Perth (AU); Rubim DE MOURA, East Perth (AU); Ian PARRY, East Perth (AU)

(73) Assignee: FORTESCUE METALS GROUP LTD, East Perth, Western Australia (AU)

(21) Appl. No.: 17/788,228

(22) PCT Filed: Dec. 23, 2020
(86) PCT No.: PCT/AU2020/051430

§ 371 Date: Jun. 22, 2022

(30) Foreign Application Priority Data
Dec. 23, 2019 (AU) 2019904913

(51) Int. Cl. B60T 7/16; B60T 17/22; B60T 8/94; B60T 8/88; B61L 15/00; B60T 13/68; B61D 29/00

(52) U.S. Cl. CPC B60T 7/16; B60T 17/228; B60T 8/94; B60T 8/885; B61L 15/0027; B60T 13/683; B61D 29/00; B60T 2270/88

(57) ABSTRACT

The present invention provides a braking system (11) for braking a train. The system comprises an electronically controlled pneumatic brake network (ECP) and a brake activation unit (14). The brake activation unit provides status reports regarding the condition of the ECP and comprises at least one sensor for monitoring one or more properties of the ECP, and at least one venting means adapted to vent the pressure from a brake pipe (21). The system also comprises a telecommunication network (15, 17, 19) adapted to communicate with the brake activation unit. The brake activation unit can be activated using the telecommunication network to vent the pressure from the brake pipe, causing the train to brake.

### TECHNICAL FIELD

The present invention generally relates to a braking system and a brake activation unit for a heavy haul transportation vehicle, in particular, a train.

### BACKGROUND ART

The use of a train to transport large volumes of goods long distances is commonplace. In the mining industry, for example, trains, many kilometres in length, are used to transport ore from mine site to port.

In the mining industry, trains typically comprise two or more diesel electric locomotives which provide the driving means to move hundreds of wagons from one site to another and back again. These trains run on a single set of dual rails with sidings formed along the track to allow passing of trains travelling in opposite directions. The tracks are a critical piece of infrastructure for the mine and it is essential that the tracks are in optimum working condition to ensure trains are not delayed and the mining company has sufficient ore at port to immediately load a ship.

Currently, trains rely on a lead set of locomotives to drive the train. Long train consists will sometimes have another set of locomotives in the middle of the consist. For some rail lines, another locomotive set will be stationed at the base of a gradient and will connect to the consist in order to push the consist over the hill. The locomotives control the speed and braking of the wagons and are in communication with each other, as well as with each wagon in the consist. The locomotives in the consist are controlled from the lead locomotive.

Due to the nature of the operations and the length of the trains, it is critical that braking of the train is predictable and reliable. To ensure this is the case, each train consist has a number of braking systems to assist with braking and to provide a backup should one system fail.

One method that is used by the mining industry in Australia is the primary braking system relies on the application of a braking system on each locomotive as well as each wagon. This primary braking system is referred to as an Electronically Controlled Pneumatic brake network (ECP). The ECP comprises a master control device located in the lead locomotive, and a brake control device in each wagon (Car Control Devices (CCDs)).

The CCDs are connected to the lead locomotive via a train power-line (train-line) that extends along the length of the train. This train line also enables communication between the CCDs. When a braking event occurs, the signal is sent along the train line, causing each wagon to apply (or release) its own braking equipment. The application is substantially simultaneous along the length of the train, eliminating forces caused when the train takes up the inherent slack between wagons as a result of the couplings.

The CCDs are also interconnected by a continuous brake pipe running the length of the train consist. The brake pipe is positively pressurised to maintain the braking system in a disengaged condition for each wagon. The brake pipe is in communication with a compressor in the locomotives.

In normal operation, the pressure in the brake pipe remains above a safe operational value. In the event that the pressure drops below this value, such as may occur when a discontinuity is created in the brake pipe, the brakes are caused to be applied. This form of braking is a backup and is only applied during an emergency situation.

The ECP incorporates an end of train unit which monitors the condition of the trainline and the brake pipe system and is typically located on the rear of the last wagon of the train consist. The end of train unit continuous checks train-line continuity, and communicates the status of the train line, as well as the pressure in the brake pipe to the lead locomotive. In the event that the end of train unit registers an irregular or erroneous signal, such as when the end of train unit identifies that the communications, the power of the train line and/or the pressure within the brake pipe are not within certain parameters, the operator of the lead locomotive is alerted and appropriate action can then be taken by the operator.

In the event of a fault with the trainline power, the CCDs in the wagons are unable to talk to/communicate with the trainline communications controller (TCC) in the lead locomotive. If this fault is not addressed/rectified within a set period, currently one hour, the ECP braking system will move from an electronic mode to a pneumatic mode. If there is pressure in the brake pipe when this occurs, the wagon brakes will release, and the train is free to move. This can, and has resulted in a run-away train.

While the ECP braking system has a degree of redundancy, an irregular or erroneous signal is still reliant on the action of the operator of the lead locomotive. If the operator does not, or is unable to take the necessary action, the situation may occur where the train consist becomes a runaway.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

It is an object of this invention to provide a braking system which ameliorates, mitigates or overcomes at least one disadvantage of the prior art, or which will at least provide the public with a practical choice.

Throughout the specification the term ‘train’ and ‘train consist’ are used interchangeably to describe a set of locomotives coupled to a plurality of wagons.

The present invention provides a braking system for braking a train, the system comprises:
an electronically controlled pneumatic brake network (ECP);
a brake activation unit, the brake activation unit providing status reports regarding the condition of the ECP, the brake activation unit comprising:
   at least one sensor for monitoring one or more properties of the ECP; and
   at least one venting means adapted to vent the pressure from a brake pipe;
a telecommunication network adapted to communicate with the brake activation unit;
wherein the brake activation unit can be activated using the telecommunication network to vent the pressure from the brake pipe, causing the train to brake.

The at least one sensor may monitor the pressure of the brake pipe, and/or the integrity of a train line.

The venting means may be movable from a non-venting condition, wherein the ECP operates in its usual manner, and a venting condition, wherein the air is vented from the brake pipe.

Preferably the brake activation unit is activated when the condition of the ECP, as reported by the brake activation unit, is in conflict to the required condition of the train. For example, where the train is stationary but the brake activation unit indicates the brakes have been released, the brake activation unit may be activated to vent the pressure from the brake pipe, causing the brakes to re-engage, preventing the train from moving.

The brake activation unit may be activated remotely to move to a venting condition.

In one embodiment, the brake activation unit may be activated through the telecommunication network which may take the form of a mobile or cellular phone telecommunications network.

In another embodiment, the brake activation unit may be activated through a dedicated telecommunications network.

The telecommunications network may comprise a series of base stations and transmitting towers. The telecommunication network may incorporate radio receivers within one or more locomotives. The radio receivers may be in communication with the brake activation unit. Upon receiving a signal, the radio receivers may convert the signal to an analogue signal before sending the signal to the brake activation unit.

The brake activation unit may be activated remotely by the operator in the train or by an operator located in a different geographical location, such as the train controller. The brake activation unit may be activated remotely when various conditions relating to the status of the train are met.

Once activated, the brake activation unit may remain in a venting condition until it is deactivated. In order to deactivate the brake activation unit a venting component (such as a solenoid valve or dump valve) is required to be replaced or it must be physically reset to the non-venting condition, allowing the brake pipe to recharge. The brake activation unit may be reset from the locomotive.

The brake activation unit may include diagnostic capabilities to monitor the venting operation of the brake pipe and the states of actuation of the various components.

The brake activation unit may incorporate a dump valve controlled by a solenoid, the dump valve may be movable between an open condition wherein the solenoid is energised, and wherein the air in the brake pipe may be vented, and a closed condition wherein the solenoid is de-energised and the ECP is in its normal operational condition whereby the brake pipe is closed at the end thereof.

The dump valve and/or the brake activation unit may comprise a visual indicator, such as one or more lights, which is activated upon the brake activation unit being activated to vent the air from the brake pipe. Alternatively, activation of the brake activation unit to vent the air can result in a different lighting pattern of a set of indicators/LEDs.

In one embodiment, the brake activation unit may be incorporated in an end of train unit, and is preferably removably supported on the train at an end thereof. The dump valve may be associated with an end of the brake pipe whereupon moving to an open position the air is discharged from the brake pipe through the end thereof. Preferably the brake activation unit will be operable when the end of train unit is operable. That is, if the end of train unit is turned off the brake activation unit will not be able to operate.

In another embodiment, the brake activation unit is incorporated in at least one of the locomotives, but preferably all the locomotives. The dump valve may be associated with a locomotive brake pipe within the locomotive, whereupon the solenoid being energised the dump valve moves to an open position allowing the air to be vented or discharged from the locomotive brake pipe through the valve. As the train brake pipe is in fluid communication with the locomotive brake pipe, the air in the train brake pipe may also be vented through the valve. As there is no pressure in the brake pipe the brakes are caused to be applied. In this embodiment the brake activation unit is independent of the end of train unit and is therefore operable regardless of the operative state, or presence of the end of train unit.

The present invention further provides a brake activation unit which upon activation causes the train to brake, the brake activation unit comprises:
at least one venting means adapted to vent the pressure from a brake pipe of the train;
a telecommunication network adapted to communicate with the venting means to selectively move the venting means to an open position to vent the pressure from the brake pipe.

The present invention provides a braking system having a brake activation unit which incorporates a venting means which can be remotely activated to vent the pressure from the brake pipe to cause the brakes to be applied along the train consist.

Preferably the brake activation unit comprises a brake pipe sensor for measuring the pressure in the brake pipe. Preferably the brake activation unit measures and reports to an operator the status of the brake pipe pressure. The brake activation unit may measure the pressure at a position at the end of the train. The brake activation unit may use an electronically controlled pneumatic brake network trainline to report to the operator.

The brake activation unit may comprise a marker light which illuminates when the brake activation unit is correctly installed and is in an operational condition, which is typically an upright orientation.

The brake activation unit may transmit a substantially continuous or repeating signal along the ECP trainline to the locomotive. If the locomotive does not receive the signal the train may be caused to stop with an ECP emergency application of the brake.

When the brake activation unit is activated, the locomotive compressor may be caused to turn off so that air does not continue to be fed into the brake pipe.

The present invention provides a braking system for braking a train, the system comprises:

a pneumatic brake system;

a brake activation unit, the brake activation unit providing updates regarding the condition of the pneumatic brake system, the brake activation unit comprising:
at least one sensor for monitoring one or more properties of the pneumatic brake system; and
at least one venting means adapted to vent the pressure from a brake pipe;

a telecommunication network adapted to communicate with the brake activation unit;

wherein the brake activation unit can be activated using the telecommunication network to vent the pressure from the brake pipe, causing the train to brake.

The present invention provides a braking system for braking a train, the system comprises:

a brake network;

a brake activation unit, the brake activation unit providing status reports regarding the condition of the brake network, the brake activation unit comprising:
at least one sensor for monitoring one or more properties of the brake network; and
at least one release means adapted to release the pressure from a brake pipe of the train;

a communication network adapted to communicate with the brake activation unit;

wherein the brake activation unit can be activated using the communication network to release the pressure from the brake pipe, causing the train to brake.

The present invention provides a braking system for braking a train, the system comprises:

a brake network;

a brake activation unit, the brake activation unit providing the status of the brake network, the brake activation unit comprising:
at least one sensor for monitoring one or more properties of the brake network; and

a communication network adapted to communicate with the brake activation unit;

wherein the brake activation unit can be activated using the communication network to cause the train to brake.

The brake activation unit may be activated using the communication network to release the pressure from the brake pipe causing the train's brakes to engage.

The present invention provides a braking system for braking a train, the system comprises:

a brake network;

a brake activation unit which monitors the brake network, the brake activation unit comprising:
at least one sensor for monitoring one or more properties of the brake network; and

a communication means adapted to communicate with the brake activation unit;

wherein the brake activation unit can be activated using the communication means to cause the train to brake.

The brake activation unit may be activated using the communication network to release the pressure from the brake pipe causing the train's brakes to engage.

In one aspect of the invention, the communication means may be in the form of a communications/telecommunications network. The communications means may comprise one ore more transmitting towers and one or more receivers. The communication means may provide communication between the train and a remote location (s).

In another aspect of the invention, the communication means may be provided by the train's communication system. The train's communication system may allow for communication along the train.

In an embodiment of the present invention, the brake activation unit comprises a solenoid which may be caused to open to allow for the release of the pressure from a brake pipe. The solenoid may be in fluid communication with the brake pipe and may be located near the compressor in one of the locomotives, or may be located at the end of the train.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic of a telecommunication network which forms parts of the braking system according to a first embodiment of the system;

FIG. 2 is a cross sectional view of a brake activation unit as used in the braking system of the first embodiment:

In the drawings like structures are referred to by like numerals throughout the several views. The drawings shown are not necessarily to scale, with emphasis instead generally being placed upon illustrating the principles of the present invention.

### DESCRIPTION OF EMBODIMENTS

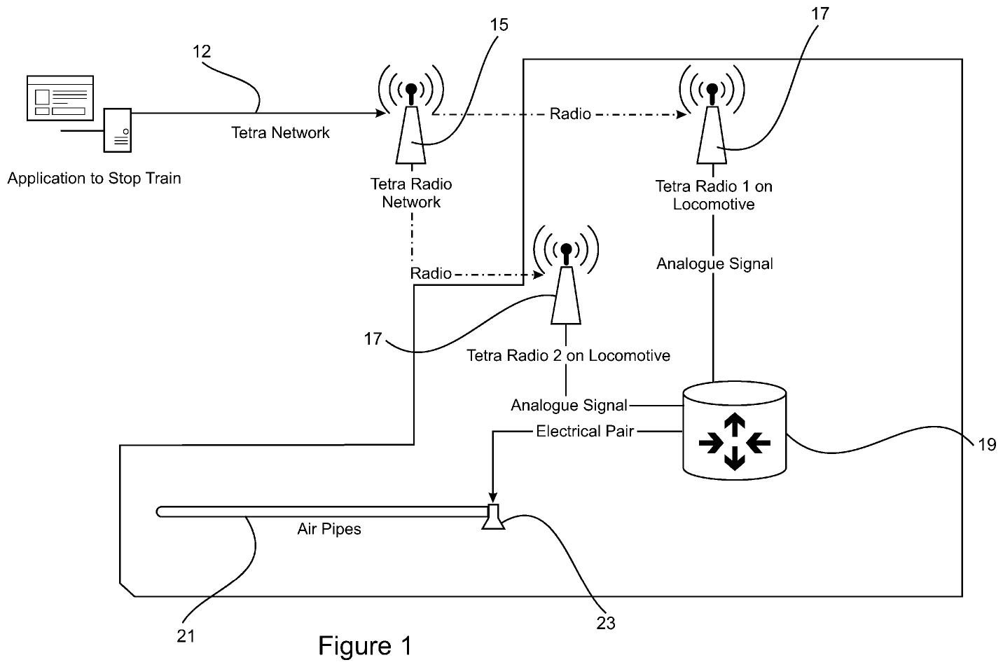

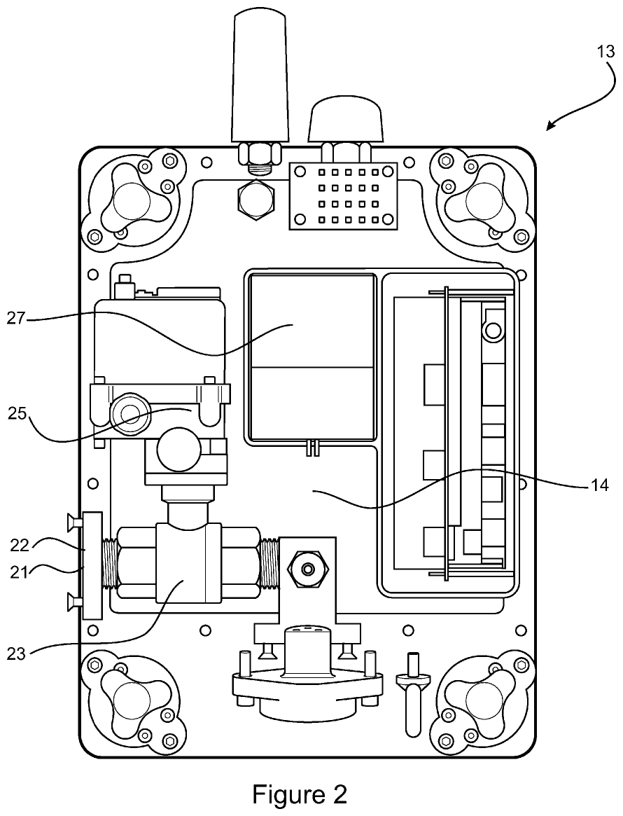

Referring to FIGS. 1 and 2, the invention according to the first embodiment is in the form of a braking system 11 which is incorporated in a train and which is capable of being activated remotely to apply the brakes of the train. The present invention seeks to provide a means to brake a train in the event that the train's conventional brake system is not responsive, or if the brakes are unintentionally released.

In the event that the status of the train (e.g. the train status should be stationary) does not align with the status of its brakes (e.g. the status of the brakes is released) the braking system of the present invention can be activated remotely to cause the brakes to be applied.

While present day braking systems incorporate several options for braking a train, there is no option available for at least an emergency application of brakes when the present day braking systems are non-responsive, or when the status of the braking system is contrary to the required operative status of the train.

A train typically comprises two or more locomotives and a plurality of wagons. The train has a number of braking systems which brake or otherwise retard the velocity of the train. One of these systems is an electronically controlled pneumatic brake network (ECP).

As part of the ECP each wagon (typically) incorporates a set of brakes and a braking apparatus, which controls the application and release of the brakes on the particular wagon. The braking apparatus is in electronic communication with the lead locomotive via a trainline which extends along the length of the train and reacts to commands sent from the lead locomotive via the trainline.

As a back-up, the ECP also includes a pneumatic brake pipe which also runs along the length of the train. Under normal conditions the brake pipe is positively charged. However, in the event that the electronic braking system is non-responsive the pressure/air in the brake pipe may be caused to vent, resulting in the brakes being applied. Currently this occurs as a result of the action of the operator, or due to a break of the train (e.g. coupling breaks/uncoupling of wagons).

In this embodiment the braking system 11 comprises an ECP which co-operates with an end of train unit 13, as shown in FIG. 2. The end of train unit 13 is in communication with the lead locomotive via the trainline to provide status reports regarding the condition of the ECP.

The end of train unit comprises a brake activation unit 14. The brake activation unit 14 comprises a sensor for monitoring the brake pressure in the brake pipe 21, and a venting means in the form of a dump valve 23. The dump valve 23 is located at the end of the brake pipe 21 so that when it is opened it vents the pressure/air from the brake pipe 21. The dump valve 23 is operable by a solenoid 25 which, when energised, causes the dump valve 23 to open. Once the dump valve 23 is opened the brake activation unit 14 can only be reset by the physical action of an operator and cannot be reset remotely.

The braking system 11 also comprises a telecommunication network 12 adapted to communicate with the end of train unit 13. Referring to FIG. 1 the telecommunications network comprises a series of transmitting towers 15 located along the railway network and at least one receiver 17 located in each locomotive. Each receiver 17 is in communication with a relay 19 of the brake activation unit 14.

The brake activation unit 14 is activated remotely and is not reliant on a command from the locomotive control systems.

In those events where the status of the train is contrary to the position of the brakes, and the locomotive operator does not or is unable to undertake corrective action, the brake activation unit 14 may be activated. For example, where the train should be stationary, but the brakes are released, the brake activation unit 14 may be activated to apply the brakes.

In the event that the brakes need to be applied, the train controller, who may be in a different geographical location to the train can send a signal through the telecommunication network 12 to the relay 19 in the brake activation unit 14. The relay 19 then energises the solenoid 25, causing the dump valve to move to an open condition. This allows the pressure/air to be vented from the end of the brake pipe 21, causing the brakes to be applied.

The brake activation unit also comprises a battery 27 so that the brake activation unit may continue to operate in the event the locomotive is not able to supply the brake activation unit with power.

The brake activation unit must be capable of running all components using the battery for a minimum period of time, for instance 12 hrs.

The brake activation unit may have a Bluetooth interface, a serial interface or similar for administrative control of the unit.

It is preferred that the brake activation unit of the present invention:
has the ability to stop the train at any time at any location on the rail network;
be able to activate the locomotive pneumatic brake system separate from any other locomotive system;
can ensure that the reduced air pressure will activate normal locomotive safety function such as removal of tractive effort;
be able to be manually overridden from at least within the locomotive (there being no automatic or remote override available for the system);
be able to interact and activate the locomotive pneumatic brake system on an individual locomotive;
is under constant monitoring and is available at all times.

The train braking solution is intended to provide a backup method to remotely stop a train in the case of an emergency. The brake activation unit is attached to a relay box that when triggered results in air being dumped from the braking system and the locomotive being brought to a halt. The signal to trigger the relay is communicated to the transmitting assembly by a message sent across the telecommunication network and received by a radio incorporated in the brake activation unit. An output from the relay box is then fed through the brake activation unit so it can communicate success/failure back through the radio network.

Each brake activation unit will only accept messages from a predesignated source.

An embodiment of the present invention provides an increase in functionality to the prior art braking systems by remotely enabling emergency venting (i.e. an emergency brake application) of the train's brake pipe in an undefined train system failure scenario. The brake activation unit addresses those circumstances where the operator of the lead locomotive does not, or is unable to take any necessary action.

The brake activation unit may form part of an end of train unit to vent pressure from the end of the brake pipe, but may also be incorporated within the locomotive to vent pressure from the front of the brake pipe. When located in the locomotive the activation unit may rely on the train's communication system.

Modifications and variations such as would be apparent to the skilled addressee are considered to fall within the scope of the present invention. For example, the present invention may readily apply to other vehicles, such as trucks. These embodiments are considered to fall within the scope of the present invention.

The present invention is not to be limited in scope by any of the specific embodiments described herein. These embodiments are intended for the purpose of exemplification only. Functionally equivalent products, formulations and methods are clearly within the scope of the invention as described herein.

Reference to positional descriptions, such as lower and upper, are to be taken in context of the embodiments depicted in the figures, and are not to be taken as limiting the invention to the literal interpretation of the term but rather as would be understood by the skilled addressee.

Throughout this specification, unless the context requires otherwise, the word “comprise” or variations such as “comprises” or “comprising”, will be understood to imply the inclusion of a stated integer or group of integers but not the exclusion of any other integer or group of integers.

While the invention has been shown and described with reference to certain exemplary embodiments thereof, it will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

The method steps, processes, and operations described herein are not to be construed as necessarily requiring their performance in the particular order discussed or illustrated, unless specifically identified as an order of performance. It is also to be understood that additional or alternative steps may be employed.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Such variations are not to be regarded as a departure from the disclosure, and all such modifications are intended to be included within the scope of the disclosure.

It will be understood that when an element is referred to as being “connected” or “coupled” to another element, it may be directly connected or coupled to the other element or intervening elements may be present. As used herein the term “and/or” includes any and all combinations of one or more of the associated listed items.

1. A braking system for braking a train, the system comprises:
an electronically controlled pneumatic brake network (ECP);
a brake activation unit, the brake activation unit providing status reports regarding the condition of the ECP, the brake activation unit comprising:
at least one sensor for monitoring one or more properties of the ECP; and
at least one venting means adapted to vent the pressure from a brake pipe;
a telecommunication network adapted to communicate with the brake activation unit;
wherein the brake activation unit can be activated using the telecommunication network to vent the pressure from the brake pipe, causing the train to brake.

2. The braking system according to claim 1 wherein the at least one sensor monitors the pressure of the brake pipe, and/or the integrity of a train line.

3. The braking system according to claim 1 wherein the venting means is movable from a non-venting condition, wherein the ECP operates in its usual manner, and a venting condition, wherein the air is vented from the brake pipe.

4. The braking system according to claim 1 wherein the brake activation unit is activated when the condition of the ECP, as reported by the brake activation unit, is in conflict to the required condition of the train.

5. The braking system according to claim 1 wherein the brake activation unit is activated remotely to move to a venting condition.

6. The braking system according to claim 1 wherein the brake activation unit is activated through the telecommunication network.

7. The braking system according to claim 1 wherein the brake activation unit is activated through a dedicated telecommunications network.

8. The braking system according to claim 1 wherein the telecommunications network comprises a series of base stations and transmitting towers.

9. The braking system according to claim 1 wherein the telecommunication network incorporates radio receivers within one or more locomotives.

10. The braking system according to a claim 1 wherein the brake activation unit is activated remotely by the operator in the train or by an operator located in a different geographical location.

11. The braking system according to claim 1 wherein the brake activation unit remains in a venting condition once activated until it is deactivated, wherein deactivation requires replacement of a venting component, or the physically resetting of the brake activation unit to the non-venting condition, allowing the brake pipe to recharge.

12. The braking system according to claim 1 wherein the brake activation unit is reset from the locomotive.

13. The braking system according to claim 1 wherein the brake activation unit incorporates a dump valve controlled by a solenoid, the dump valve is movable between an open condition wherein the solenoid is energised, and wherein the air in the brake pipe can be vented, and a closed condition wherein the solenoid is de-energised and the ECP is in its normal operational condition whereby the brake pipe is closed at the end thereof.

14. The braking system according to claim 13 wherein the dump valve and/or the brake activation unit comprises a visual indicator, such as one or more lights, which is activated upon the brake activation unit being activated to vent the air from the brake pipe.

15. The braking system according to claim 1 wherein the brake activation unit is incorporated in an end of train unit, and is removably supported on the train at an end thereof.

16. The braking system according to claim 15 when dependent on claim 13 wherein the dump valve is associated with an end of the brake pipe whereupon moving to an open position the air is discharged from the brake pipe through the end thereof.

17. The braking system according to claim 15 wherein the brake activation unit will be operable when the end of train unit is operable.

18. The braking system according to claim 1 wherein the brake activation unit is incorporated in at least one of the locomotives, wherein a dump valve is associated with a locomotive brake pipe within the locomotive, whereupon a solenoid being energised the dump valve moves to an open position allowing the air to be vented or discharged from the locomotive brake pipe through the valve.

19. A brake activation unit which upon activation causes the train to brake, the brake activation unit comprises:
at least one venting means adapted to vent the pressure from a brake pipe of the train;
a telecommunication network adapted to communicate with the venting means to selectively move the venting means to an open position to vent the pressure from the brake pipe.

20. A braking system having a brake activation unit which incorporates a venting means which can be remotely activated to vent the pressure from the brake pipe to cause the brakes to be applied along the train consist.
